(19) United States
(12) Patent Application Publication
(10) Pub. No.: US 2023/0173521 A1
(43) Pub. Date: Jun. 8, 2023

(54) LIQUID SPRAYING SYSTEM

(71) Applicant: VALEO SYSTEMES D'ESSUYAGE, La Verriere (FR)

(72) Inventors: Maxime BAUDOUIN, La Verrierre (FR); Theophile JULLIEN, La Verriere (FR)

(73) Assignee: VALEO SYSTEMES D'ESSUYAGE, La Verriere (FR)

(21) Appl. No.: 17/795,412

(22) PCT Filed: Dec. 14, 2020
(86) PCT No.: PCT/EP2020/085933

§ 371 Date: Jul. 26, 2022

(30) Foreign Application Priority Data
Jan. 28, 2020 (FR) FR2000822

(51) Int. Cl. B05B 12/08; F16K 11/24; F16K 17/04; B60S 1/56; B60S 1/48; F16K 17/06

(52) U.S. Cl. CPC B05B 12/085; F16K 11/24; F16K 17/0406; B60S 1/56; B60S 1/481; F16K 17/06

(57) ABSTRACT

The present invention relates to a system for spraying a washing liquid, comprising a washing liquid tank, a plurality of spray members fluidically connected to the tank, a pump configured to supply the spray members with washing liquid, a plurality of valves coupled respectively to the plurality of spray members and configured to selectively transmit the pumped washing liquid to the respective spray members, wherein the plurality of valves are disposed in the form of a distribution block with an inlet of the block being configured to be fluidically connected to the pump and comprising fluidic connectors disposed in parallel and intended to be connected to spray members, and wherein the distribution block also comprises a mechanical overpressure valve disposed in parallel with the fluidic connectors and configured to be fitted on a fluidic connector of the distribution block.

### CROSS-REFERENCE TO RELATED APPLICATIONS

This application is filed under 35 U.S.C. §371 U.S. National Phase of International Application No. PCT/EP2020/085933 filed Dec. 14, 2020 (published as WO2021151573), which claims priority benefit to French application No. 2000822 filed on Jan. 28, 2020, the disclosures of which are herein incorporated by reference in their entirety.

### TECHNICAL FIELD

The present invention relates to the field of liquid spraying systems for motor vehicles.

### BACKGROUND OF THE INVENTION

Motor vehicles all have a cleaning liquid spraying system for keeping the windscreen of the vehicle clean and allowing the driver to see out optimally.

Moreover, with the multiplication of sensors, in particular optical driving assistance sensors, the number of spray systems has multiplied to allow proper operation of these optical sensors, which are generally exposed to dirt from the external environment.

In order to avoid multiplying the number of components, it is known practice for certain components of the spraying systems to be shared, such as the pump or the tank between the different spraying systems. Valves are then used to direct and transmit the pumped cleaning liquid to the spray end pieces (or spray nozzles) selected.

However, such configurations require a more powerful pump and a higher pressure level, for example greater than 6 bar, compared with “conventional” cleaning systems just for the windscreen.

Such a pressure level can bring about risks of damage to the material and risks for the safety of users, however.

Therefore, it is necessary for it to be possible to control the maximum pressure in the hydraulic circuit of the spraying system in order to make it possible to use less expensive components and to avoid such risks.

### BRIEF SUMMARY OF THE INVENTION

To this end, a system for spraying a washing liquid is proposed, comprising:
a washing liquid tank,
at least one spray member fluidically connected to the tank,
a pump configured to supply the at least one spray member with washing liquid,
at least one valve coupled respectively to the at least one spray member and configured to selectively transmit the pumped washing liquid to the at least one respective spray member,

wherein the at least one valve is disposed in the form of a distribution block with an inlet of the block being configured to be fluidically connected to the pump and comprising fluidic connectors disposed in parallel and intended to be connected to the at least one spray member, and wherein the distribution block also comprises a mechanical overpressure valve disposed in parallel with the fluidic connectors and configured to be fitted on one fluidic connector of the distribution block.

The use of an overpressure valve in the distribution block makes it possible to limit the pressure in the spraying system, making it possible to use less robust, and therefore less expensive, elements while ensuring that users are protected. Moreover, the disposition in a distribution block allows a high level of modularity, a small size and simplified maintenance.

According to one embodiment, there are a plurality of spray members and a plurality of valves coupled respectively to said plurality of spray members.

According to one embodiment, the mechanical overpressure valve comprises a ¼ turn interface at its inlet.

According to another embodiment, the overpressure valve comprises an outlet nose configured to be fluidically connected to a return hose in the direction of the tank.

According to another embodiment, the overpressure valve comprises a seal-ball-spring assembly configured such that the ball moves away from the seal when the pressure exceeds a predetermined value.

According to another embodiment, the overpressure valve also comprises a screw or a preloading nut for the spring, configured to adjust the predetermined value.

According to another embodiment, the predetermined value is between 5 and 6 bar.

According to another embodiment, the overpressure valve comprises a casing made of plastics material.

According to another embodiment, the valves are solenoid valves.

According to another embodiment, the distribution block is a modular block in which the number of valves can be adapted depending on the number of spray members to be supplied.

According to another embodiment, the fluidic connectors are standard connectors.

### BRIEF DESCRIPTION OF THE DRAWINGS

Further features and advantages of the invention will become more clearly apparent from reading the following description, which is given by way of illustrative and non-limiting example, and from the appended drawings, in which:

FIG. 1 shows a diagram of a system for spraying a washing liquid;

FIG. 2 shows a view of an overpressure valve in longitudinal section;

FIG. 3 shows a first perspective view of an overpressure valve;

FIG. 4 shows a second perspective view of an overpressure valve;

FIG. 5 shows a third perspective view of an overpressure valve;

FIG. 6 shows a fourth perspective view of an overpressure valve;

FIG. 7 shows a diagram of a distribution block.

### DETAILED DESCRIPTION OF THE INVENTION

The following embodiments are examples. Although the description refers to one or more embodiments, this does not necessarily mean that each reference relates to the same embodiment, or that the features apply only to one embodiment. Individual features of different embodiments may also be combined or interchanged to provide other embodiments.

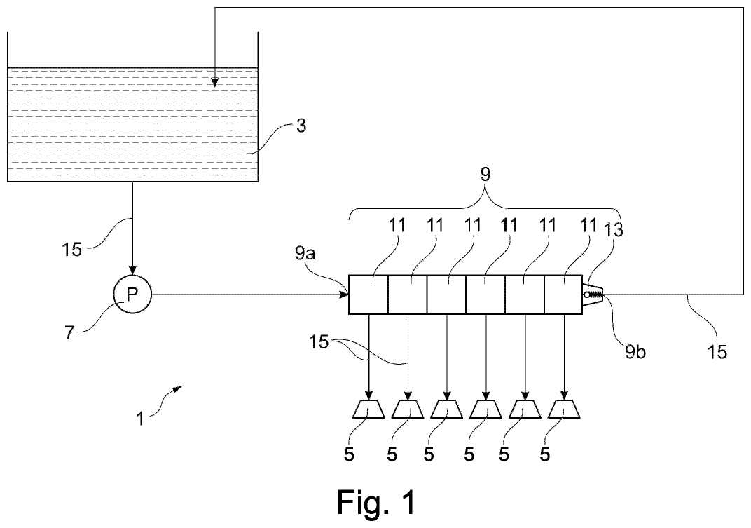

Embodiments of the invention relate to a system 1 for spraying a washing liquid, in particular for motor vehicles, which is shown schematically in FIG. 1. The spraying system 1 comprises a washing liquid tank 3, a plurality of spray members 5 (six in the present case), for example spray nozzles, a pump 7 and a distribution block 9 comprising a plurality of valves 11 (six in the present case) and a mechanical overpressure valve 13. The different elements of the spraying system 1 are fluidically connected for example by pipes or hoses 15. The arrows on the pipes 15 indicate the direction of flow of the washing liquid.

The pump 7 is configured to pump the washing liquid from the tank 3 and sent it to the distribution block 9 and the spray members 5. The valves 11 of the distribution block 9 are configured to be fluidically connected respectively to the different spray members 5. The valves 11 are configured to selectively transmit the pumped washing liquid to the associated spray members 5. The valves 11 are for example solenoid valves. The valves 11 are disposed in parallel, meaning that they are all connected to a fluidic channel of the distribution block 9. This fluidic channel is connected to an inlet 9a of the distribution block 9 that is connected to the pump 7, and to an outlet 9b of the distribution block 9 that is connected to the tank 3. The overpressure valve 13 is for example disposed at the outlet 9b of the distribution block 9.

Thus, in operation, the activation of the pump 7 makes it possible to transmit the washing liquid from the tank 3 to the distribution block 9 and to the spray members 5, the associated valve 11 of which is open. Moreover, when the pressure of the washing liquid in the distribution block 9 exceeds a predefined value, the overpressure valve 13 is configured to allow the liquid to return to the tank 3 and thus to limit the pressure in the spraying system 1 and in particular in the distribution block 9 and in the hoses 15. This limiting of the pressure makes it possible to limit the risks of the various elements breaking and to use less expensive and lighter elements while ensuring the safety of passengers of the vehicle in the case of a spraying system of a motor vehicle.

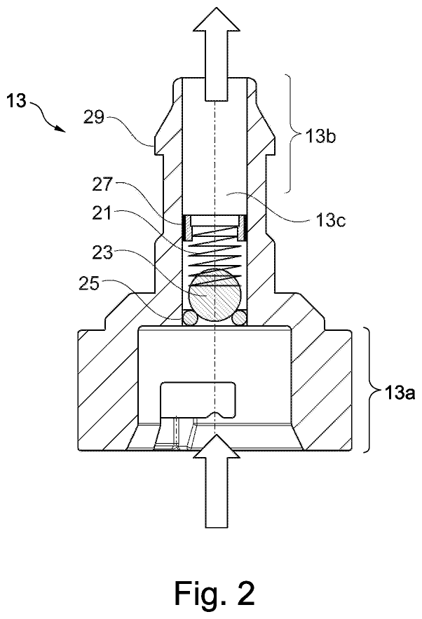

FIG. 2 shows a view in longitudinal section of a mechanical overpressure valve 13 comprising an elastic element 21, in this case a coil spring, configured to urge a ball 23 against a seal 25, for example an O-ring seal. The stiffness of the spring 21 can be chosen depending on the predefined pressure value. Moreover, the spring 21 may be in abutment against an adjustable stop 27, for example a screw or a preloading nut, making it possible to apply a preload to the coil spring 21 so that it is possible to adjust the predefined pressure value. The predefined value is for example between 5 and 6 bar.

The overpressure valve 13 also comprises an inlet 13a in fluidic communication with an outlet 13b of the valve 13 and a fluidic channel 13c which connects the inlet 13a to the outlet 13b and in which the ball 23 is disposed. The arrows at the inlet 13a and the outlet 13b indicate the direction of flow of the liquid. Thus, in operation, as long as the pressure of the fluid is below the predefined valve, the washing liquid is stopped by the ball 23 which is in contact with the O-ring seal 25. When the pressure of the liquid on the ball 23 exceeds the predefined pressure, the ball 23 compresses the spring 21 such that a space is formed between the ball 23 and the O-ring seal 25, thereby allowing the washing liquid to pass through. If the pressure drops below the predefined value again, the ball 23 is placed against the O-ring seal 25 again under the effect of the spring 21, such that the ball 23 prevents the washing liquid from passing through. This ball 23-spring 21 combination makes it possible to obtain an uncertainty of around +/−5% with respect to the predefined value.

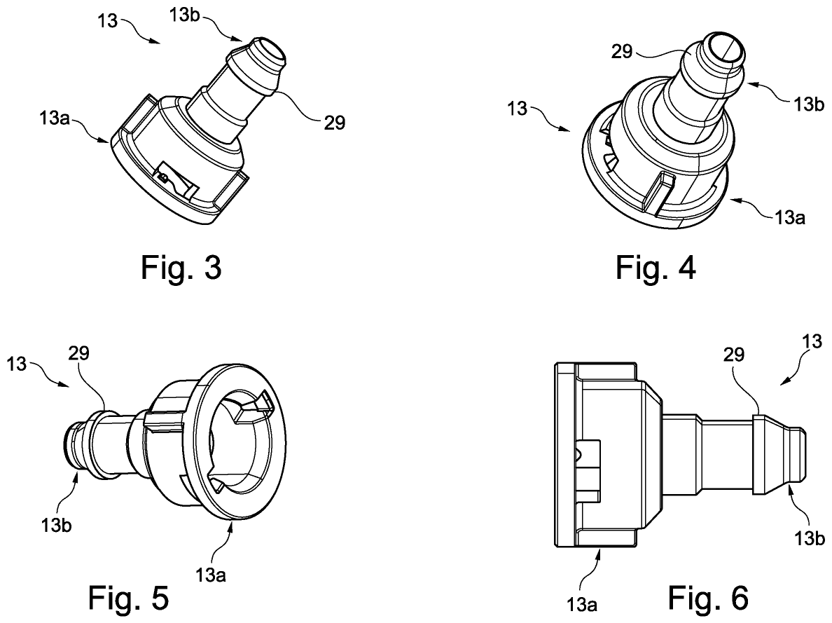

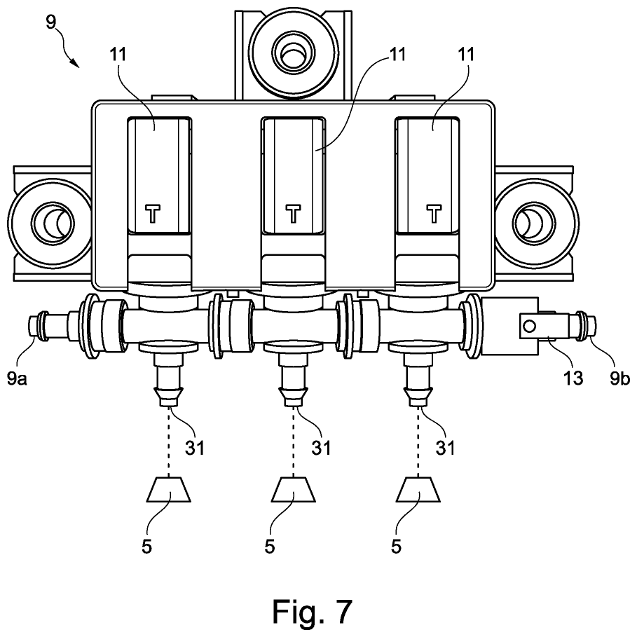

Moreover, as can be seen better in FIGS. 3 to 6, the overpressure valve 13 may comprise a ¼ turn interface at the inlet 13a so that it can be fixed quickly and easily to a complementary end piece of the distribution block 9 corresponding to a fluidic connector 31 (visible in FIG. 7). A seal (not shown), for example of the conical seal type, may also be disposed at the inlet 13a to ensure the leaktightness of the interface at the complementary end piece. The overpressure valve 13 may also comprise a nose with a collar 29 and a shape that narrows towards its end at its outlet to allow a hose or pipe 15 to be fixed to it. The shape of the nose also corresponds to the shape of a fluidic connector 31 such that the overpressure valve can be inserted between a fluidic connector 31 and a pipe 15. The casing of the overpressure valve 13 may be made in one piece and may be made of plastics material.

FIG. 7 shows an exemplary embodiment of a distribution block 9 comprising three solenoid valves 11 that are disposed in parallel and associated respectively with three fluidic connectors 31 intended to be connected to spray members 5. The solenoid valves 11 are disposed along a fluidic channel connecting the inlet 9a and the outlet 9b of the distribution block 9. An overpressure valve 13 as described above is also disposed at the outlet 9b of the distribution block 9. The overpressure valve 13 is configured to be fitted on a standard fluidic connector 31 of the distribution block 9. However, it should be noted that the overpressure valve 13 can also be disposed at another location, for example in the place of one of the fluidic connectors 31, the outlet 13b of the overpressure valve 13 still being fluidically connected to the tank 3. The distribution block 9 is a modular block and so the number of solenoid valves 11 can easily be modified to adapt to the number of spray members 5, for example depending on the model of the motor vehicle if the spraying system 1 is disposed on a motor vehicle. Different distribution blocks 9 can also be combined. In this case, the overpressure valve 13 may be disposed at the common outlet of the set of distribution blocks 9. The fluidic connectors 31 of the distribution block 9 are, for example, standard connectors.

Thus, the use of a modular distribution block makes it possible to adjust the size of the distribution block depending on the number of spray members to be supplied and the use of standard fluidic connectors allows the connection of hoses or pipes 15 and of an overpressure valve. The overpressure valve makes it possible to ensure that the pressure in the spraying system does not exceed a threshold value, making it possible to ensure the safety of the users while making it possible to use equipment requiring a resistance to a pressure greater than the threshold value, this making it possible to use equipment with a lower cost.

What is claimed is:

1. System for spraying a washing liquid, comprising:
at least one valve, said at least one valve being intended to be coupled to a tank and, respectively, to at least one spray member, and being configured to selectively transmit a washing liquid pumped from said tank to the at least one respective spray member,
wherein the at least one valve is disposed in the form of a distribution block with an inlet of the block being configured to be fluidically connected to the pump and comprising fluidic connectors disposed in parallel and intended to be connected to the at least one spray member, and wherein the distribution block also comprises a mechanical overpressure valve disposed in parallel with the fluidic connectors and configured to be fitted on one of the fluidic connectors of the distribution block.

2. Spraying system according to claim 1, wherein there are a plurality of spray members, and a plurality of valves coupled respectively to said plurality of spray members

3. Spraying system according to claim 1. wherein the mechanical overpressure valve comprises a ¼ turn interface at its inlet

4. Spraying system according to claim 1, wherein the overpressure valve comprises an outlet nose configured to be fluidically connected to a return hose in the direction of the tank.

5. Spraying system according to claim 1, wherein the overpressure valve comprises a seal-ball-spring assembly configured such that the ball moves away from the seal when the pressure exceeds a predetermined value.

6. Spraying system according to claim 4, wherein the overpressure valve also comprises a screw or a preloading nut for the spring, configured to adjust the predetermined value.

5. Spraying system according to claim 5, wherein the predetermined value is between 5 and 6 bar.

8. Spraying system according to claim 1, wherein the overpressure valve comprises a casing made of plastics material.

9. Spraying system according to claim 1, wherein the vales are solenoid valves.

10. Spraying system according to claim 1, wherein the distribution block is a modular block in which the number of valves can be adapted depending on the number of spray members to be supplied.

11. Spraying system according to claim 1, wherein the fluidic connectors are standard connectors.
